(19) United States
(12) Patent Application Publication
(10) Pub. No.: US 2025/0021850 A1
(43) Pub. Date: Jan. 16, 2025

(54) DELETION OPERATIONS IN QUANTUM DATABASE SYSTEMS

(71) Applicant: Abu Dhabi University, Abu Dhabi (AE)

(72) Inventors: Hichem El Euch, Abu Dhabi (AE); Mohammed Abdellatif Abdelaal Zidan, Assuit (EG); Montasir Yousouf Abdallah Qasymeh, Abu Dhabi (AE)

(73) Assignee: Abu Dhabi University, Abu Dhabi (AE)

(21) Appl. No.: 18/221,271

(22) Filed: Jul. 12, 2023

(51) Int. Cl. G06N 10/20

(52) U.S. Cl. CPC G06N 10/20

(57) ABSTRACT

A quantum method, includes initializing, by a quantum circuit, four registers in the quantum circuit. The quantum method further includes searching, by the quantum circuit, database data states in register |QDB> that match criteria specified in register |qr>. The quantum method further includes applying, by the quantum circuit, an S operator. The quantum method further includes applying, by the quantum circuit, the |h|+1-qubit Toffoli gate with |h| control qubits of the register |QDB>. The quantum method further includes removing, by the quantum circuit, an effect of the S operator. The quantum method further includes applying, by the quantum circuit, n of 3-qubit Toffoli gates. The quantum method further includes applying, by the quantum circuit, additional n of another 3-qubit Toffoli gates. The quantum method further includes deleting, by the quantum circuit, marked data/records/basis states based on the applying n of other 3-qubit Toffoli gates.

### BACKGROUND

Databases are used in various computing systems to store transactional information. The main operations conducted on databases include insert operations, update operations, delete operations, and search operations. Currently, there is no effective systems that can provide such operations for databases associated with quantum computing systems.

### BRIEF DESCRIPTION OF DRAWINGS

FIG. 1 is a diagram of an example system;

FIG. 2A is a diagram of an example quantum circuit;

FIG. 2B is a diagram of an example quantum circuit;

FIG. 3 is an example of an example table;

FIGS. 4 and 5 are diagrams of example graphs;

FIG. 6 is a diagram of an example computing device; and

FIG. 7 is a diagram of an example computing device.

### DETAILED DESCRIPTION OF PREFERRED EMBODIMENTS

The following detailed description refers to the accompanying drawings. The same reference numbers in different drawings may identify the same or similar elements.

Systems, devices, and/or methods described herein may provide for one or more quantum circuit systems that provided for database delete operations. In embodiments, a particular quantum circuit may be a delete circuit which performs delete record(es) operations in quantum databases (QDBs) based on input criteria with complexity O(1) without violating the No-deleting Theorem. In embodiments, the particular quantum circuit may be used to delete specific data (states) from a uniform/weighted superposition QDB. In embodiments, the operation speed of the particular circuit is exponentially increased compared to previous systems.

Accordingly, the systems, devices, and/or methods described herein can be used to delete a greater amount of data into a quantum database system, which cannot be achieved using non-quantum computers or other systems. In embodiments, the one or more quantum circuits provide for a more efficient deletion of information from one or more databases and can overcome issues of requiring more time associated with non-quantum systems. In embodiments, the delete operation may have a database system that is integrated with AI (artificial intelligence)/quantum-AI and information systems. Grover's algorithm, which is a quantum search algorithm, that reduces the search process within a database system to be O(N^{1/2}) (where N is the number of items database, compared with traditional algorithms that need O(N). Thus, quantum computers have a significantly greater speed (such as a quadratic speed) to perform such search operations when compared to a non-quantum computer.

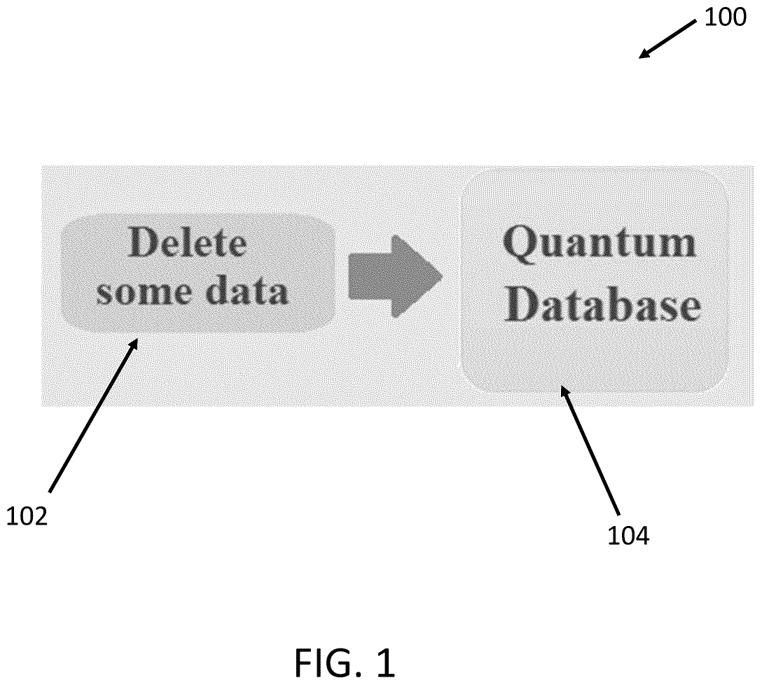

FIG. 1 shows an example diagram 100 of conducting a deletion operation on a quantum database. In FIG. 1, delete operation 102 is shown and may be used to interact with database 104. In FIG. 1, database 104 may include one or more uniform/weighted quantum databases that may obtain information from one or more devices. As such, delete operation 102 may be used to delete information from a quantum database (QDB) 104 more efficiently than other systems.

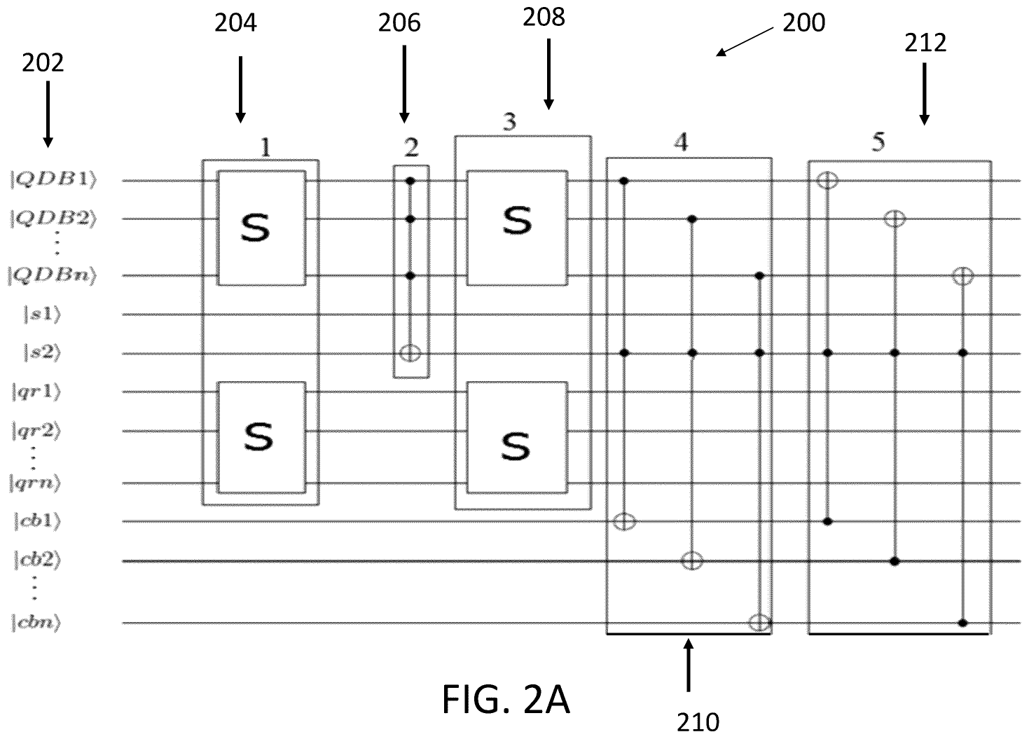

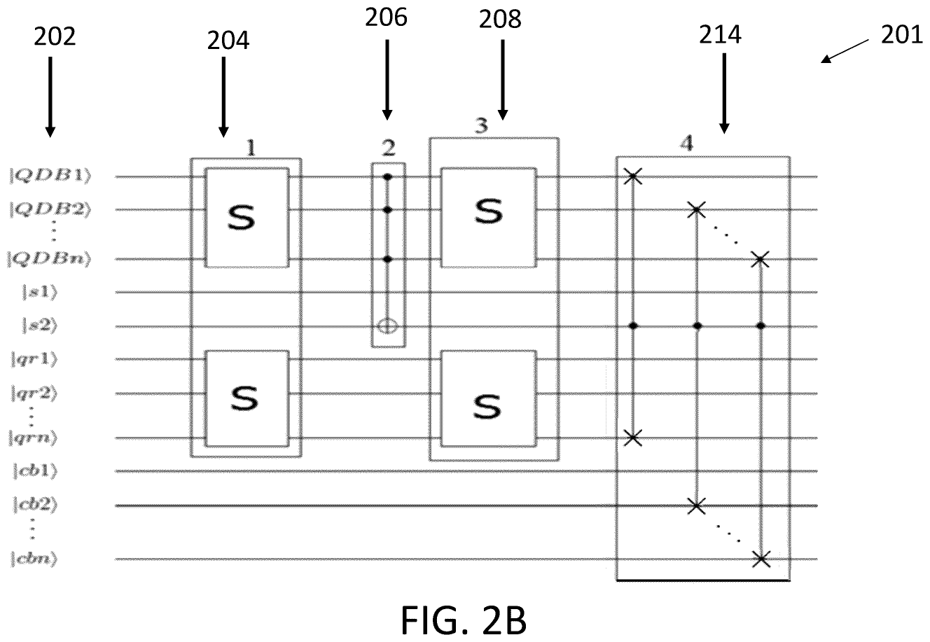

FIG. 2 is an example quantum circuit 200. In embodiments, quantum circuit 200 may be used to conduct a delete operation on a particular quantum database (s) (e.g., database 104). In embodiments, |QDB> is the register which stores a uniform/weighted QDB data/records/basis states. In embodiments, the register Is) is the same register which is used to make the insert operation. |qr> is the register which carries the criteria used to specify the data/states needed to be deleted from the QDB. In embodiments, |cb> is an ancilla register initialized to the vacuum state |00 . . . 0>.

At step 202, quantum circuit 200 initializes the quantum state as |φ₀>)=|qᵣ, QDB, cb, s>. In embodiments, the register |qr> is the quantum register which carry the criteria, conditions, to specify quantum data/records/basis states needed to deleted, the register |QDB> carry the quantum database which was stored by the insert circuit operation, |cb> is the control register of size n qubit and |s> is the register which is used in the insert process.

At step 204, the algorithm searches for the quantum database data/record(s) in the register |QDB> that match the criteria specified by the database user/information system application via the register |qr>, where the index of each qubit which its value is defined by the user/completion system is determined in the set h. In embodiments, by applying the S operator between the query register |qr> and the |QDB> register as

$$\vert {φ}_{1} 〉 = {S}_{{q}_{r} QDB} \vert {φ}_{0} 〉 = {\prod }_{h} {CNOT}_{{q}_{{r}_{h}} {QDB}_{h}} {NOT}_{{QDB}_{h}} \vert {φ}_{0} 〉 .$$

In embodiments, the search for the matched records/data/basis states is done by applying the S operator between each qubit has an index in the set h.

At step 206, quantum circuit 200 applies the |h|+1-qubit Toffoli gate with |h| control qubits of the register |QDB> which are have indexes specified by the set h and the target qubit is |s₂>. In embodiments, |φ₂>=T_{QDB}_{_{i∈h}}ₛ_{₂}^{|h|}|φ₁>.

In embodiments, at step 206, the Toffli-gate is applied to mark by entanglement the data/records/basis states which match the criteria defined by the register |qr> to delete them in step 5 (step 212) and makes it ready to store a new data/record(s)/basis states in the next insert operation by making the state of |s₂> qubit is |1> for deleted states.

At step 208, quantum circuit 200 uses the algorithm to remove the effect of S operator by applying S operator again (by repeating step 202). In embodiments,

$$\vert {φ}_{3} 〉 = {S}_{{q}_{r} QDB} \vert {φ}_{2} 〉 = {\prod }_{h} {CNOT}_{{q}_{{r}_{h}} {QDB}_{h}} {NOT}_{{QDB}_{h}} \vert {φ}_{2} 〉 .$$

At step 210, quantum circuit 200 applies n of 3-qubit Toffoli gates as follows:

$$\vert {φ}_{4} 〉 = {\prod }_{k = 1}^{n} {T}_{{QDB}_{k} {s}_{2} {cb}_{k}}^{2} \vert {φ}_{3} 〉 .$$

In embodiments, at step 210, quantum circuit 200 writes the marked data/record(s)/basis state(s) to the ancillary register |cb> by applying number of n of a 3-qubit Toffoli gate is controlled by the qubit |QDBₖ>, |s₂>, and the target qubit is |cbₖ> where k=1, 2, . . . , n.

At step 212, quantum circuit 200 applies n of a 3-qubit Toffoli gate as follows:

$$\vert {φ}_{5} 〉 = {\prod }_{k = 1}^{n} {T}_{{cb}_{k} {s}_{2} {QDB}_{k}}^{2} \vert {φ}_{4} 〉 .$$

In embodiments, step 212 deletes the marked data/record(s)/basis state(s) by converting them to the vacuum state |0>^{⊗n} by applying number of n of a 3-qubit Toffoli gate, each gate is controlled by the qubit |cbₖ>, |s₂>, and the target qubit is |QDBₖ> where k=1, 2, . . . , n. At the end, the marked basis state/states of the register |QDB> is/are leaved in the in the vacuum state |0>^{⊗n} entangled with the qubit |s₂> to make the deleted data/record(s)/basis state(s), is/are ready for storing new data/records/basis state(s) in next insert operations. FIG. 2B is another example quantum circuit 201. As shown in FIG. 2B, quantum circuit 201 has features similar to steps 202, 204, 206, and 208. However, steps 210, and 212 may be replaced by n of controlled-Swap gates (step 214) such that this gate swaps the states of the registers |cb> and |QDB> when the state of the control qubit |s₂> is |1>. Thus, FIG. 2B shows the updated circuit when using controlled-Swap gates.

Accordingly, performance of quantum circuits 200, and 201 is exponentially faster than when compared to traditional algorithms. Also, quantum circuits 200, and 201 can be used to delete a set of data/records/basis states with different values in a superposition at the same time which cannot achieve via traditional computers.

In a non-limiting example, a quantum database is given in the form of:

$$\vert QDB 〉 = \frac{1}{\sqrt{128}} ( \vert 0010010 〉 + \vert 0100100 〉 + \vert 0111010 〉 + \vert 1001100 〉 ) + \sqrt{\frac{124}{128}} \vert 0000000 〉 ,$$

In embodiments, deletion of a particular set of data is needed to satisfy the criteria |0??1???> which means that the value of the first qubit is |0>, and the value of fourth qubit is |1>. In embodiments, the set h is h={1,4}, hence |h|=2, where | . . . | defines the number of elements.

In this non-limiting example, using the quantum circuit 200, or 201, at step 202, initialize the quantum states as

$$\vert {φ}_{0} 〉 = \vert {q}_{r} , QDB , cb , s 〉 , thus :$$

$$\vert {φ}_{0} 〉 = \frac{1}{\sqrt{128}} ( \vert 0 \text{??} 1 \text{??} \text{?, 0010010, 0000000, 00〉 +} \vert 0 \text{??} 1 \text{??} \text{?, 0100100, 0000000, 00〉 +} \vert 0 \text{??} 1 \text{??} ? , 0111010 , 0000000 , 00 〉 + \vert 0 \text{??} 1 \text{??} ? , 1001100 , 0000000 , 00 〉 ) + \sqrt{\frac{124}{128}} \vert 0 \text{??} 1???, 0000000, 0000000, 01〉.$$

In this non-limiting example, at step 204, the quantum circuit 200, or 201 applies |h|=2 of S gates as:

$$\vert {φ}_{1} 〉 = {S}_{{q}_{r} QDB} \vert {φ}_{0} 〉 = {\prod }_{h} {CNOT}_{{q}_{{r}_{h}} {QDB}_{h}} {NOT}_{{QDB}_{h}} \vert {φ}_{0} 〉$$

$$\vert {φ}_{1} 〉 = \frac{1}{\sqrt{128}} ( \vert 0 \text{??} 1 \text{??} \text{?, 1010010, 0000000, 00〉 +} \vert 0 \text{??} 1 \text{??} \text{?, 1100100, 0000000, 00〉 +} \vert 0 \text{??} 1 \text{??} ? , 1111010 , 0000000 , 00 〉 + \vert 0 \text{??} 1 \text{??} ? , 0001100 , 0000000 , 00 〉 ) + \sqrt{\frac{124}{128}} \vert 0 \text{??} 1???, 1000000, 0000000, 01〉.$$

In this non-limiting example, at step 206, the quantum circuit 200, or 201 applies the |h|+1-qubit, 3-qubit, Toffoli gate with |h| control qubits of the register |QDB> which are have indexes specified by the set h and the target qubit is |s₂>. Thus:

$$\vert {φ}_{2} 〉 = {T}_{{QDB}_{1} {QDB}_{4} {s}_{2}}^{2} \vert {φ}_{1} 〉$$

$$\vert {φ}_{2} 〉 = \frac{1}{\sqrt{128}} ( \vert 0 \text{??} 1 \text{??} \text{?, 1010010, 0000000, 00〉 +} \vert 0 \text{??} 1 \text{??} \text{?, 1100100, 0000000, 00〉 +} \vert 0 \text{??} 1 \text{??} ? , 1111010 , 0000000 , 01 〉 + \vert 0 \text{??} 1 \text{??} ? , 0001100 , 0000000 , 00 〉 ) + \sqrt{\frac{124}{128}} \vert 0 \text{??} 1???, 1000000, 0000000, 01〉.$$

In this non-limiting example, at step 208, the quantum circuit 200, or 201 removes the effect of S operator by applying S operator again between (thus, repeating step 1). Thus:

$$\vert {φ}_{3} 〉 = {S}_{{q}_{r} QDB} \vert {φ}_{2} 〉 = {\prod }_{h} {CNOT}_{{q}_{{r}_{h}} {QDB}_{h}} {NOT}_{{QDB}_{h}} \vert {φ}_{2} 〉$$

$$\vert {φ}_{3} 〉 = \frac{1}{\sqrt{128}} ( \vert 0 \text{??} 1 \text{??} \text{?, 0010010, 0000000, 00〉 +} \vert 0 \text{??} 1 \text{??} \text{?, 0100100, 0000000, 00〉 +} \vert 0 \text{??} 1 \text{??} ? , 0111010 , 0000000 , 01 〉 + \vert 0 \text{??} 1 \text{??} ? , 1001100 , 0000000 , 00 〉 ) + \sqrt{\frac{124}{128}} \vert 0 \text{??} 1???, 0000000, 0000000, 01〉.$$

In this non-limiting example, at step 4 (step 210), quantum circuit 200 applies n=7 of a 3-qubit Toffoli gate as follows:

$$\vert {φ}_{4} 〉 = {\prod }_{k = 1}^{n} {T}_{{QDB}_{k} {s}_{2} {cb}_{k}}^{2} \vert {φ}_{3} 〉$$

$$\vert {φ}_{4} 〉 = \frac{1}{\sqrt{128}} ( \vert 0 \text{??} 1 \text{??} \text{?, 0010010, 0000000, 00〉 +} \vert 0 \text{??} 1 \text{??} \text{?, 0100100, 0000000, 00〉 +} \vert 0 \text{??} 1 \text{??} ? , 0111010 , 0111010 , 01 〉 + \vert 0 \text{??} 1 \text{??} ? , 1001100 , 0000000 , 00 〉 ) + \sqrt{\frac{124}{128}} \vert 0 \text{??} 1???, 0000000, 0000000, 01〉.$$

The at step 5 (step 210), quantum circuit 200 applies n=7 of a 3-qubit Toffoli gate as follows:

$$\vert {φ}_{5} 〉 = {\prod }_{k = 1}^{n} {T}_{{cb}_{k} {s}_{2} {QDB}_{k}}^{2} \vert {φ}_{4} 〉$$

$$\vert {φ}_{5} 〉 = \frac{1}{\sqrt{128}} ( \vert 0 \text{??} 1 \text{??} \text{?, 0010010, 0000000, 00〉 +} \vert 0 \text{??} 1 \text{??} \text{?, 0100100, 0000000, 00〉 +} \vert 0 \text{??} 1 \text{??} ? , 0000000 , 0111010 , 01 〉 + \vert 0 \text{??} 1 \text{??} ? , 1001100 , 0000000 , 00 〉 ) + \sqrt{\frac{124}{128}} \vert 0 \text{??} 1???, 0000000, 0000000, 01〉.$$

In alternate embodiments, the results |φ₄>, and |φ₅> can be obtained directly by applying at step 4 (step 214), in the quantum circuit 201 instead of applying the step 4 (step 210), and the step 5 (step 212), in the quantum circuit 200.

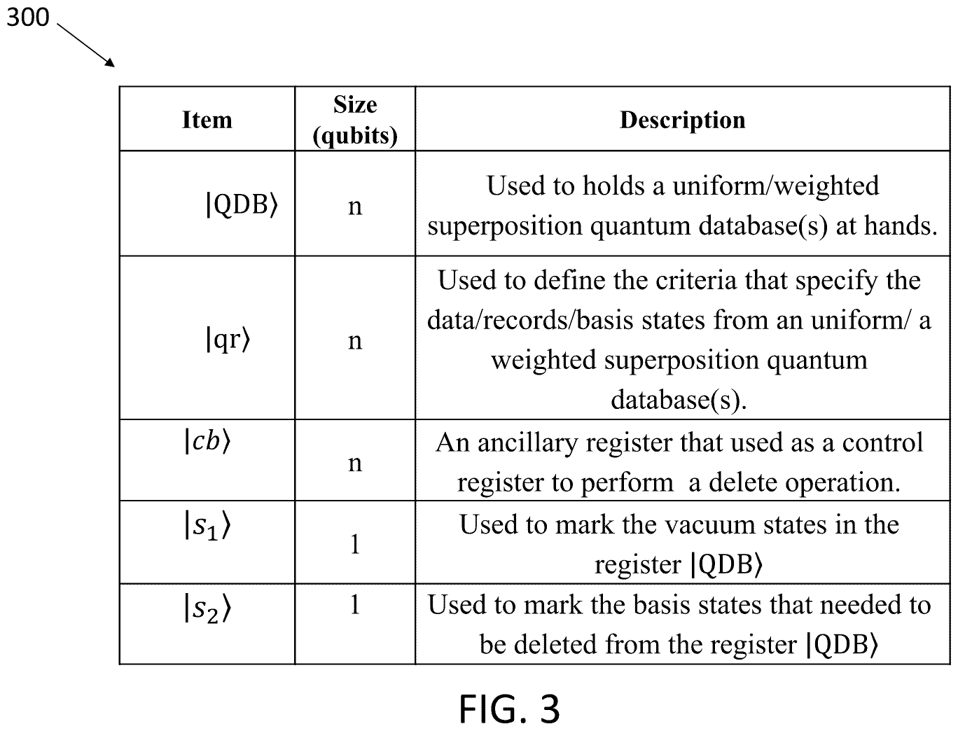

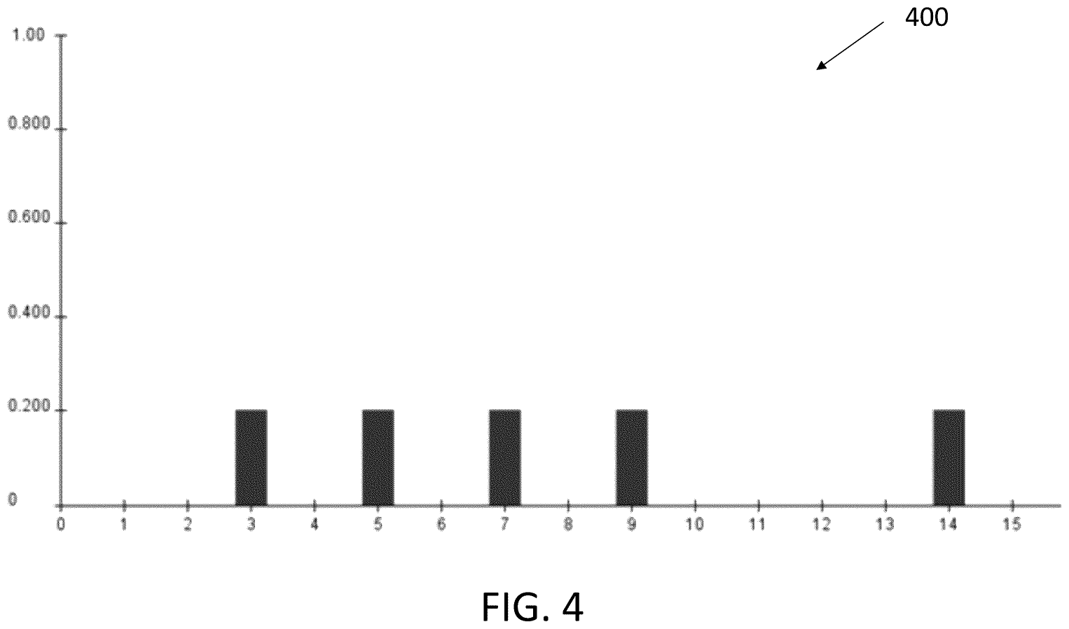

FIG. 3 is an example table 300 that describes each of the features that are part of 202 described in FIGS. 2A and 2B. FIG. 4 is an example graph 400. In embodiments, graph 400 may be generated based on quantum inputs into a computing device, such as device 600 and generate graphs (based on a simulator, such as Javantum simulator) that represent simulations. In embodiments graph 400 displays state probabilities. In this non-limiting example, to implement a delete operation, a quantum database of a uniform superposition is provided in the following form:

$$\vert QDB 〉 = \frac{1}{\sqrt{5}} ( \vert 0011 〉 + \vert 0101 〉 + \vert 0111 〉 + \vert 1001 〉 + \vert 1110 〉 ) .$$

In this non-limiting example, each two qubits represent an attribute in the quantum database. As shown in FIG. 4, graph 400 has an x-axis (horizontal axis) that represents quantum database basis states and a y-axis (vertical axis) that represents probability. Each bar represents probabilities occurring at various quantum database basis states.

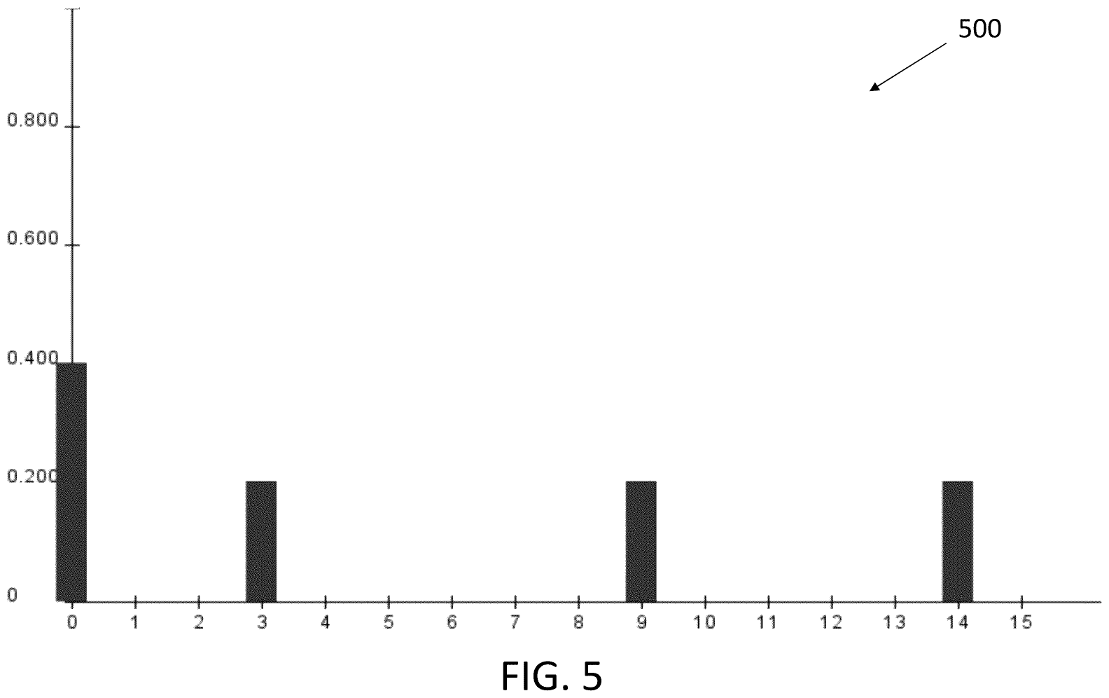

FIG. 5 is an example graph 500. In embodiments, graph 500 may be generated based on quantum inputs into a computing device, such as device 600 and generate graphs (based on a simulator, such as Javantum simulator) that represent simulations. In embodiments graph 500 displays state probabilities. In regards to the quantum database associated with FIG. 5, suppose that it is required to delete the set of data which satisfy the criterion that the state of the first two qubits is |01>. Thus, it is expected that the basis states |5>=|0101>, and |7>=|0111> are deleted from the quantum database. After applying the proposed delete circuit via the simulator the results are shown in FIG. 5. As shown in FIG. 5, graph 500 has an x-axis (horizontal axis) that represent quantum database basis states and a y-axis (vertical axis) that represents probability. Each bar represents probabilities occurring at various quantum database basis states.

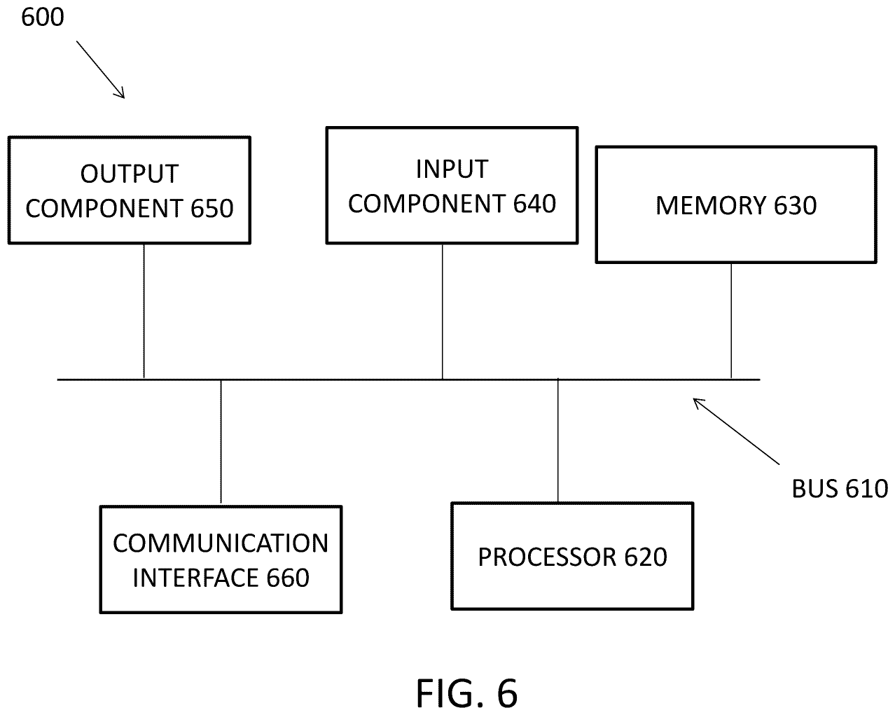

FIG. 6 is a diagram of example components of a device 600. Device 600 may correspond to a computing device, such as devices that may use database 104. As shown in FIG. 6, device 600 may include a quantum bus 610, a quantum processor 620, a quantum memory 630, quantum input component 640, quantum output component 650, and a communications interface 660. In other implementations, device 600 may contain fewer components, additional components, different components, or differently arranged components than depicted in FIG. 6. Additionally, or alternatively, one or more components of device 600 may perform one or more tasks described as being performed by one or more other components of device 600.

Quantum bus 610 may include a path that permits communications among the components of device 600. Quantum processor 620 may include one or more processors, microprocessors, and/or processing logic (e.g., a field programmable gate array (FPGA), quantum teleportation devices, quantum communication devices, quantum computing circuits, quantum encryption applications and/or an application specific integrated circuit (ASIC) that interprets and executes instructions. Input component 640 may include a mechanism that permits a user to convert classical information to quantum input information to device 600, such as a quantum circuit, a quantum-based application, a keyboard, a keypad, a button, a switch, voice command, etc. Quantum output component 650 may include a mechanism that outputs information and transforms quantum information to classical information to be provided to the user, such as a display, a speaker, one or more light emitting diodes (LEDs), etc.

Quantum communications interface 660 may include any transceiver-like mechanism that enables device 600 to communicate with other devices and/or systems. For example, communications interface 660 may include an Ethernet interface, an optical interface, a coaxial interface, a wireless interface, or the like and quantum-to-classical and vice versa unit.

In another implementation, quantum communications interface 660 may include, for example, a transmitter that may convert baseband signals from quantum processor 620 to radio frequency (RF) signals and/or a receiver that may convert RF signals to baseband signals. Alternatively, communications interface 660 may include a transceiver to perform functions of both a transmitter and a receiver of wireless communications (e.g., radio frequency, infrared, visual optics, quantum wireless, quantum channels, quantum fiber optics, quantum teleportation, quantum communication devices/networks, quantum encryption devices, etc.), wired communications (e.g., conductive wire, twisted pair cable, coaxial cable, transmission line, fiber optic cable, waveguide, single-photon channels, multi-photon channels, etc.), or a combination of wireless and wired communications.

Communications interface 660 may connect to an antenna assembly (not shown in FIG. 6) for transmission and/or reception of the RF signals, and/or quantum channels. The antenna assembly may include one or more antennas to transmit, quantum channels and/or receive RF signals over the air. The antenna assembly may, for example, receive RF signals and/or quantum information from communications interface 660 and transmit the RF signals over the air, and receive RF signals over the air and provide the RF signals to communications interface 660. In one implementation, for example, communications interface 660 may communicate with a network (e.g., a wireless network, quantum network, quantum channel, wired network, Internet, quantum internet, etc.). In embodiments, an antenna may be implemented by quantum teleportation protocols, quantum communication protocols and/or quantum encryption protocols.

As will be described in detail below, device 600 may perform certain operations. Device 600 may perform these operations in response to quantum processor 620 executing software instructions (e.g., computer program(s), quantum computing circuit, quantum teleportation, etc.) contained in a computer-readable medium/quantum-based computing, such as quantum memory 630, a secondary storage device (e.g., hard disk, CD-ROM, etc.), or other forms of RAM or ROM. A computer-readable medium may be defined as a non-transitory memory device. A memory device may include space within a single physical memory device or spread across multiple physical memory devices. The software instructions may be read into memory 630 from another computer-readable medium or from another device. The software instructions contained in quantum memory 630 may cause quantum processor 620 to perform processes described herein. Alternatively, hardwired circuitry may be used in place of or in combination with software instructions to implement processes described herein. Thus, implementations described herein are not limited to any specific combination of hardware circuitry and software.

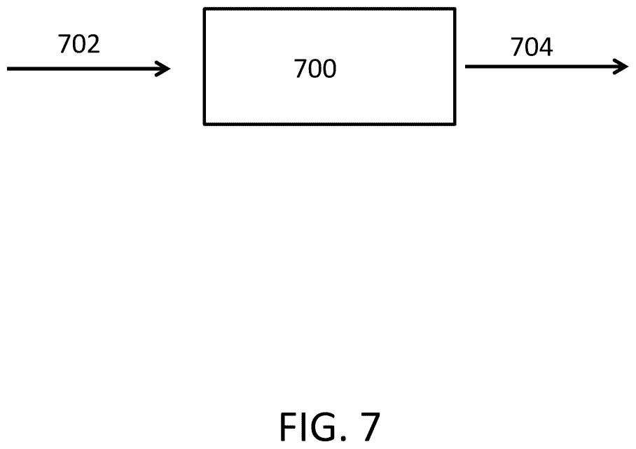

FIG. 7 is an example diagram of a computing device. FIG. 7 describes device 700, input 702, and output 704. In embodiments, device 700 may a computing device with features/structures similar to that described in FIG. 6. In embodiments, device 700 may be a computing device that is part of a laptop, desktop, tablet, smartphone, quantum computer, quantum computing device, quantum communication device, quantum internet device, and/or any other device. In embodiments, device 700 may include database 104, similar to that described in the above figures.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

While various actions are described as selecting, displaying, transferring, sending, receiving, generating, notifying, and storing, it will be understood that these example actions are occurring within an quantum computing, quantum networking, quantum database, quantum computing and/or quantum networking environment and may require one or more computing devices, as described in FIG. 6 or 7 to complete such actions. Furthermore, it will be understood that these various actions can be performed by using a touch screen on a computing device (e.g., touching an icon, swiping a bar or icon), using a keyboard, a mouse, or any other process for quantumally selecting an option displayed on a display screen to quantumally communicate with other computing devices, quantum computer, cloud, quantum communication devices, and/or quantum networks. Also, it will be understood that any of the various actions can result in any type of quantum information and/or quantum information to be displayed in real-time and/or simultaneously on multiple user devices. Any quantum graphs and/or quantum information may be generated by a computing device, such as device 600, and displayed via a graphical user device (GUI) or cloud environment.

No element, act, or instruction used in the present application should be construed as critical or essential unless explicitly described as such. Also, as used herein, the article “a” is intended to include one or more items and may be used interchangeably with “one or more.” Where only one item is intended, the term “one” or similar language is used. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A quantum method, comprising:
initializing, by a quantum circuit, four registers in the quantum circuit;
searching, by the quantum circuit, database data in register |QDB> that matches criteria specified in register |qr>;
applying, by the quantum circuit, an S operator;
applying, by the quantum circuit, |h|+1-qubit Toffoli gate with |h|control qubits of the register |QDB>;
removing, by the quantum circuit, an effect of the S operator;
applying, by the quantum circuit, n of 3-qubit Toffoli gates;
applying, by the quantum circuit, additional n of another 3-qubit Toffoli gates; and
deleting, by the quantum circuit, marked data/records/basis states based on applying n of other 3-qubit Toffoli gates.

2. The quantum method of claim 1, wherein the registers include |QDB>, |s>, |qᵣ>, and |cb>.

3. The quantum method of claim 2, wherein the registers |cb>, and |s> are control registers.

4. The quantum method of claim 2, wherein the register |qᵣ> is a quantum register that includes criteria to specify quantum data for deletion.

5. The quantum method of claim 4, wherein the applying the |h|+1-qubit Toffoli gate includes entangling data/records/basis states which match criteria defined by the register |qᵣ> for deletion.

6. The quantum method of claim 1, wherein the applying the n of 3-qubit Toffoli gates includes:
$$\vert {φ}_{4} 〉 = {\prod }_{k = 1}^{n} {T}_{{QDB}_{k} {s}_{2} {cb}_{k}}^{2} \vert {φ}_{3} 〉 .$$

7. The quantum method of claim 1, wherein the applying the n of other 3-qubit Toffoli gates includes:
$$\vert {φ}_{5} 〉 = {\prod }_{k = 1}^{n} {T}_{{cb}_{k} {s}_{2} {QDB}_{k}}^{2} \vert {φ}_{4} 〉 .$$

8. A quantum method, comprising:
initializing, by a quantum circuit, four registers in the quantum circuit;
searching, by the quantum circuit, database data in register |QDB> that matches criteria specified in register |qr>;
applying, by the quantum circuit, an S operator;
applying, by the quantum circuit, |h|+1-qubit Toffoli gate with |h|control qubits of the register |QDB>;
removing, by the quantum circuit, an effect of the S operator;
applying, by the quantum circuit, n of controlled-Swap gates, wherein the applying the n of controlled-Swap gates swaps states of registers |cb> and |QDB> based on a state of a control bit.
